(19) United States
(12) Patent Application Publication
(10) Pub. No.: US 2015/0333347 A1
(43) Pub. Date: Nov. 19, 2015

(54) FUEL CELL DEVICES FOR FIRE AND/OR EXPLOSION PREVENTION

(71) Applicant: Zodiac Aerotechinics, Plaisir Cedex (FR)

(72) Inventors: Yannick Brunaux, Saint CYRL'Ecole (FR); Christophe Claris, Saint Etienne (FR); Nelly Giroud, Saint Etienne (FR); Vincent Morin, Saint Chamond (FR); Oliver Vandroux, Grenoble (FR)

(21) Appl. No.: 14/384,748

(22) PCT Filed: Mar. 13, 2013
(86) PCT No.: PCT/IB2013/052002

§ 371 Date: Sep. 12, 2014

Related U.S. Application Data
(60) Provisional application No. 61/612,493, filed on Mar. 19, 2012.

(51) Int. Cl. H01M 8/04

(52) U.S. Cl. CPC H01M 8/04104; H01M 8/04201; H01M 2250/20

(57) ABSTRACT

Described are fuel cell/inerting systems (12, 20) having at least one fuel cell system (10), at least one dryer coupled en (26) to a fuel tank (40), at least one ODA flow selector valve (28) having a first outlet port coupled to a cargo bay (38), and a second outlet port coupled to the dryer (26), and a controller (36). The fuel cell/inerting system detects an amount of ODA output from the fuel cell system and transmits a signal to the ODA flow selector valve instructing the ODA flow selector valve to open both outlet ports when the controller determines that the amount of ODA output is sufficient to supply the cargo bay (38) and the fuel tank (40) or close one of the two outlet ports when the controller determines that the amount of ODA output is insufficient to supply the cargo bay and the fuel tank. ODA: Oxygen Depleted Air NEA: Nitrogen Enriched Air

### CROSS REFERENCE TO RELATED APPLICATIONS

This application is related to and claims priority benefits from U.S. Provisional Application Ser. No. 61/612,493, filed on Mar. 19, 2012, entitled “FUEL CELL ARCHITECTURE FOR INERTING SYSTEM” (“the '493 application”). The '493 application is hereby incorporated herein in its entirety by this reference.

### FIELD OF THE INVENTION

Embodiments of the present invention relate generally to the field of aerospace vehicles where fuel cell system by-products are used for inerting systems to prevent fire or explosion in aircraft tanks and cargo bays and local peripheral applications.

### BACKGROUND

A number of components on-board an aircraft require electrical power for their activation. Many of these components are separate from the electrical components that are actually required to run the aircraft (i.e., the navigation system, fuel gauges, flight controls, and hydraulic systems). For example, aircraft also have catering equipment, heating/cooling systems, lavatories, power seats, water heaters, wing heaters, fuel warmers, and other components that require power as well. Specific components that may require external power include, but are not limited to, trash compactors (in galley and/or lavatory), ovens and warming compartments (e.g., steam ovens, convection ovens, bun warmers), optional dish washer, freezer, refrigerator, coffee and espresso makers, water heaters (for tea), air chillers and chilled compartments, galley waste disposal, heated or cooled bar carts/trolleys, surface cleaning, area heaters, cabin ventilation, independent ventilation, area or spot lights (e.g., cabin lights and/or reading lights for passenger seats), water supply, water line heating to prevent freezing, charging stations for passenger electronics, electrical sockets, vacuum generators, vacuum toilet assemblies, grey water interface valves, power seats (e.g., especially for business or first class seats), passenger entertainment units, emergency lighting, wing heaters for ice protection, fuel warmers, and combinations thereof. These components are important for passenger comfort and satisfaction, and many components are absolute necessities.

Additionally, aerospace vehicles and aircraft are also typically equipped with a fuel tank inerting system in accordance with FAA regulation (FAR 25.981) issued in 2008, which requires aircraft manufacturers to minimize flammability in fuel tanks to significantly reduce the risk of explosion. By way of background, a combination of warm fuel vapor and air in a fuel tank may be ignited by a low energy spark, and is known to be a cause of aircraft crashes. The inerting system decreases the oxygen levels of the air inside the fuel tanks. The inerting system produces inert gas, such as nitrogen enriched air, by means of an air separation module that breaks down air into streams that are concentrated with individual components (i.e., oxygen, nitrogen, etc.). These inerting systems are typically referred to as on board inert gas generation system (“OBIGGS”) or fuel tank inerting system (“FTIS”).

The ASM typically includes polymeric-based components with limited life. For example, due to material aging, the polymeric-based components are commonly replaced about every 25,000-30,000 hours. Furthermore, in order to protect the ASM from contamination, particle and ozone filters are installed upstream of the ASM, which are typically replaced about every 5,000-10,000 hours. This routine ASM and filter replacement generates significant costs associated with maintenance of the inerting system.

Furthermore, additional unexpected contamination caused by failure of a component upstream of the OBIGGS (such as engine failure or piping contamination generated by an incorrect maintenance operation) may negatively impact the performance and ultimately, the life expectancy, of the components within the inerting system.

In many cases, the supply of inlet gas to the inerting system is typically extracted from hot pressurized air output from the engine combustion chambers (bleed air) or cabin air. In both cases, inlet air has to be conditioned in pressure and temperature to ensure optimum performance of the OBIGGS and the inert gas distribution into tanks. When pumped by the engine compressor (i.e., bleed air inlet), the inlet air consumption decreases engine efficiency, thereby increasing fuel consumption. When pumped by a dedicated electrical compressor (i.e., cabin air inlet), this inlet air consumption also increases power consumption by increasing the power demand on the electrical compressor. These described systems also require power to be delivered directly or indirectly from the engines, which also translates into extra fuel consumption. Accordingly, improved inerting systems are desirable.

The present inventors have thus sought new ways to generate electrical power to run on-board components, as well as to harness beneficial by-products of that electrical power generation, specifically oxygen depleted air (“ODA”), for additional fuel tank inerting system options for use on-board aircraft.

The relatively new technology of fuel cells provides a promising cleaner and quieter means to supplement energy sources already aboard aircrafts. A fuel cell has several outputs in addition to electrical power, and these other outputs often are not utilized. Fuel cell systems combine a fuel source of compressed hydrogen with oxygen in the air to produce electrical and thermal power as a main product. Water and ODA are produced as by-products, which are far less harmful than CO₂ emissions from current aircraft power generation processes.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

Various embodiments of the invention relate to a fuel cell/inerting system comprising at least one fuel cell system comprising a fuel tank feed line and an inerting system feed line, at least one inerting system comprising a gas inlet port and an NEA outlet port, at least one inerting system flow selector valve comprising a first inlet port coupled to the inerting system feed line of the at least one fuel cell system, a second inlet port coupled to a second gas supply source, and an outlet port coupled to the gas inlet port of the at least one inerting system, at least one fuel tank flow selector valve comprising a first inlet port coupled to the fuel tank feed line of the at least one fuel cell system, a second inlet port coupled to the NEA outlet port of the at least one inerting system, and an outlet port coupled to a fuel tank, a controller, and one or more processors in communication with the controller, the at least one inerting system flow selector valve, and the at least one fuel tank flow selector valve.

In various embodiments, the fuel cell/inerting system further comprises at least one ODA flow selector valve comprising an inlet port coupled to an ODA outlet port of the at least one fuel cell system, a first outlet port coupled to a cargo bay, and a second outlet port coupled to the inerting system feed line and the fuel tank feed line. At least one dryer may be coupled to the second outlet port of the at least one ODA flow selector valve. The second gas supply source may comprise at least one air preparation system.

According to certain embodiments, the fuel cell/inerting system comprises at least one fuel cell system comprising an ODA outlet port, at least one dryer coupled to a fuel tank, at least one ODA flow selector valve comprising an inlet port coupled to the ODA outlet port of the at least one fuel cell system, a first outlet port coupled to a cargo bay, and a second outlet port coupled to the at least one dryer, a controller, and one or more processors in communication with the controller. At least one cooler may be located upstream of the at least one dryer and coupled to the second outlet port of the at least one ODA flow selector valve.

In some embodiments, the fuel cell/inerting system further comprises at least one oxygen source flow selector valve comprising a first inlet port coupled to an air supply source and a second inlet port coupled to a supplemental oxygen source. In certain embodiments, an OEA outlet port of the at least one inerting system may be coupled to the air supply source.

The fuel cell/inerting system may also further comprise at least one compressor coupled to the first inlet port of the at least one oxygen source flow selector valve. An electrical power output of the at least one fuel cell system may be connected to the at least one compressor.

According to certain embodiments, the fuel cell/inerting system receives a signal instructing the controller to bypass the at least one inerting system, to supply ODA to the at least one inerting system, or to boost a mass flow to the fuel tank, transmits a signal to the at least one inerting system flow selector valve instructing the at least one inerting system flow selector valve to perform at least one of (i) closing both inlet ports when the controller is instructed to bypass the at least one inerting system, (ii) closing the second inlet port coupled to the second gas supply source when the controller is instructed to supply ODA to the at least one inerting system, or (iii) closing the first inlet port coupled to the inerting system feed line of the at least one fuel cell system when the controller is instructed to boost the mass flow to the fuel tank, and transmit a signal to the at least one fuel tank flow selector valve instructing the at least one fuel tank flow selector valve to perform at least one of (i) closing the second inlet port coupled to the NEA outlet port of the at least one inerting system when the controller is instructed to bypass the at least one inerting system, (ii) closing the first inlet port coupled to the fuel tank feed line of the at least one fuel cell system when the controller is instructed to supply ODA to the at least one inerting system, or (iii) opening both inlet ports when the controller is instructed to boost the mass flow to the fuel tank.

According to certain embodiments, the fuel cell/inerting system may detect an amount of ODA output from the at least one fuel cell system and transmit a signal to the at least one ODA flow selector valve instructing the at least one ODA flow selector valve to open both outlet ports when the controller determines that the amount of ODA output is sufficient to supply the cargo bay and the fuel tank or close one of the two outlet ports when the controller determines that the amount of ODA output is insufficient to supply the cargo bay and the fuel tank.

The fuel cell/inerting system may also detect at least one of temperature, pressure, and oxygen content of ODA output from the at least one fuel cell system or at least one of temperature, pressure, and oxygen content of NEA output from the at least one inerting system and transmit a signal to the at least one compressor to adjust a condition of the air supply entering the at least one fuel cell system when the controller determines that the at least one fuel cell system and/or the at least one inerting system is not operating optimally.

The fuel cell/inerting system may also transmit a signal to the at least one oxygen source flow selector valve instructing the at least one oxygen source flow selector valve to open both inlet ports to adjust the amount of supplemental oxygen that is mixing with the air supply when the controller determines that the at least one fuel cell system and/or the at least one inerting system is not operating optimally.

### BRIEF DESCRIPTION OF THE DRAWINGS

The specification makes reference to the following appended figures, in which use of like reference numerals in different figures is intended to illustrate like or analogous components.

FIG. 1 is a schematic example of input elements that may be used for a fuel cell system, showing the materials needed to generate electrical power (O₂ and H₂) and the output elements (H₂O, oxygen-depleted air, and heat) that may be reused by additional aircraft components.

FIG. 2 is a diagram illustrating an inerting system for a fuel tank and a cargo bay.

FIG. 3 is a diagram illustrating an inerting system for a fuel tank system.

FIG. 4 is a diagram illustrating the basic components of an inerting system.

FIG. 5 is a diagram illustrating a fuel cell/inerting system with the fuel cell system operating as a stand-alone inerting system, according to certain embodiments of the present invention.

FIG. 6 is a diagram illustrating a fuel cell/inerting system with the fuel cell system and inerting system coupled so that ODA output from the fuel cell system may be routed to a variety of locations as needed, according to certain embodiments of the present invention.

FIG. 7 is a simplified flow diagram illustrating a control method for a fuel cell/inerting system, wherein the fuel cell system operates as a stand-alone inerting system, according to certain embodiments of the present invention.

FIG. 8 is a simplified flow diagram illustrating a control method for a fuel cell/inerting system, wherein the fuel cell system provides ODA output to the inerting system, according to certain embodiments of the present invention.

FIG. 9 is a simplified flow diagram illustrating a control method for a fuel cell/inerting system, wherein the fuel cell system provides a booster to the mass flow of inert gas to a fuel tank, according to certain embodiments of the present invention.

FIG. 10 is a diagram of a computer system apparatus for the fuel cell/inerting system of FIG. 6.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Disclosed herein are systems and processes for providing inerting systems that are powered by fuel cell systems and/or incorporate by-products of fuel cell systems as inputs to the inerting systems. While the inerting systems are discussed for use in aircrafts, they are by no means so limited and may be used in buses, trains, or other forms of transportation equipped with fuel tanks or other components at risk of flammable vapor ignition, such as cargo bays. The inerting systems discussed herein also may be used in any other suitable environment. When powered by an appropriate fuel cell system and/or used in conjunction with other by-products from an appropriate fuel cell system, the inerting system's operation can be made independent of (or less dependent on) the vehicle's (or surrounding environment's) electrical power system.

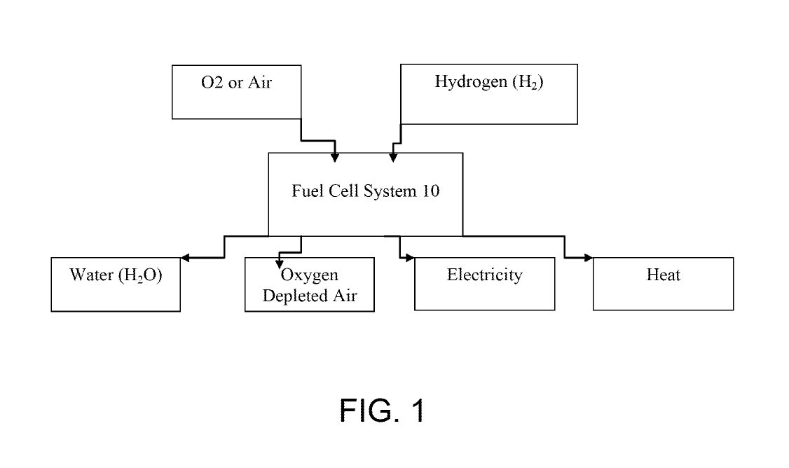

A fuel cell system 10 is a device that converts chemical energy from a chemical reaction involving hydrogen or other fuel source and oxygen rich gas (e.g., air) into usable electrical energy. As illustrated in FIG. 1, hydrogen or another fuel source combines with oxygen in the fuel cell system 10 to generate electrical energy (power). Along with the generated electrical energy, the fuel cell system 10 produces water, thermal power (heat), and ODA as by-products. Frequently, the water, heat, and ODA by-products are not used and therefore become waste.

In some embodiments, the ODA may be used for food oxidation protection (such as fruits, vegetables, etc.) and/or may be used to inflate or pressurize tires of the aircraft or vehicle when the aircraft or vehicle is on the ground and/or stationary. In other embodiments, the thermal power may be used for membrane insulation, heating of the aircraft or vehicle, and/or heating fuel stored in one or more fuel tanks 40. As disclosed herein, at least some or all of the electrical energy and ODA may be used to power or supply an inerting system 12, such as but not limited to, an inerting system used in an aircraft.

Any appropriate fuel cell system may be used, including, but not limited to, a Proton Exchange Membrane Fuel Cell (“PEMFC”), a Solid Oxide Fuel Cell (“SOFC”), a Molten Carbonate Fuel Cell (“MCFC”), a Direct Methanol Fuel Cell (“DMFC”), an Alkaline Fuel Cell (“AFC”), or a Phosphoric Acid Fuel Cell (“PAFC”). Any other existing or future fuel cell system technology, including but not limited to a hybrid solution, may also be used.

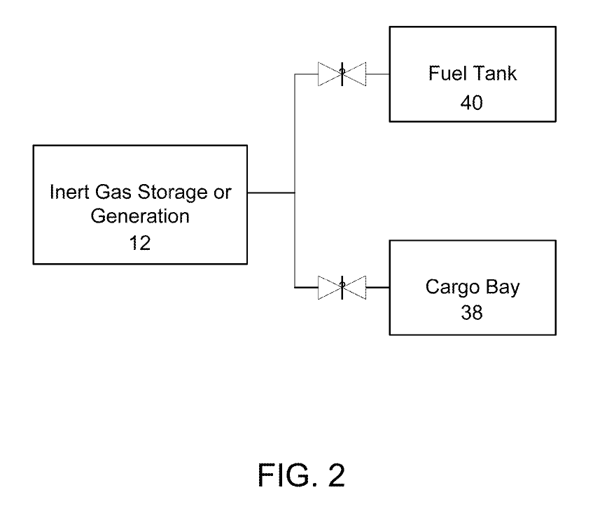

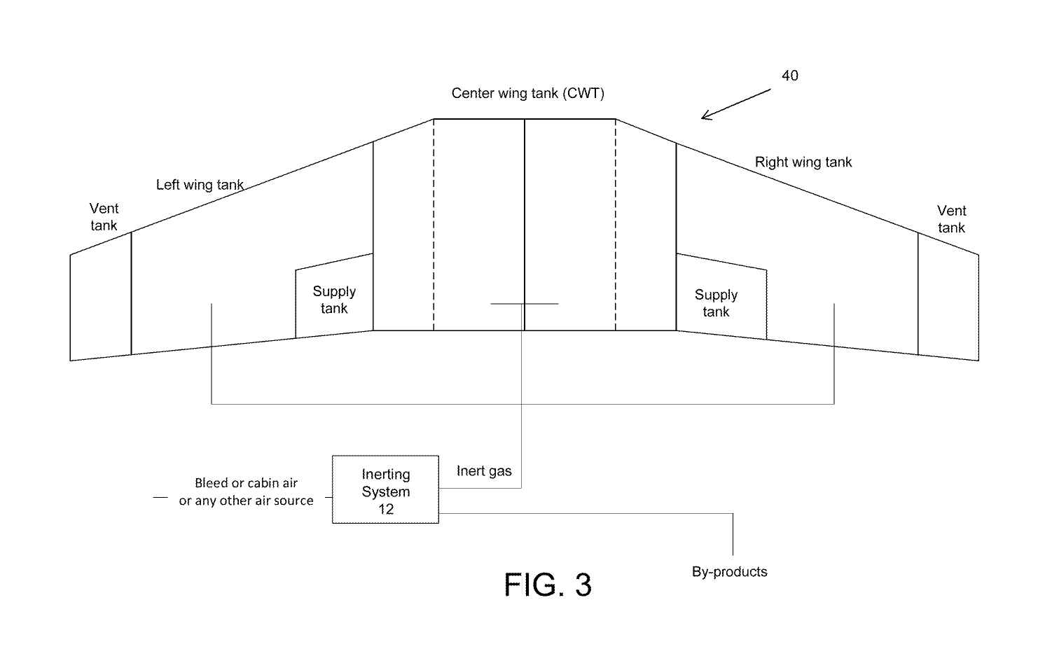

The inerting system 12 is typically used to inert fuel tanks 40 and cargo bays 38, as illustrated in FIG. 2. In some cases, the inerting system 12 is used to inert an entire fuel tank 40 system, which may include a center wing tank, left wing tank, right wing tank, vent tanks, supply tanks, aft tanks, and/or any other fuel tank location, as shown in FIG. 3.

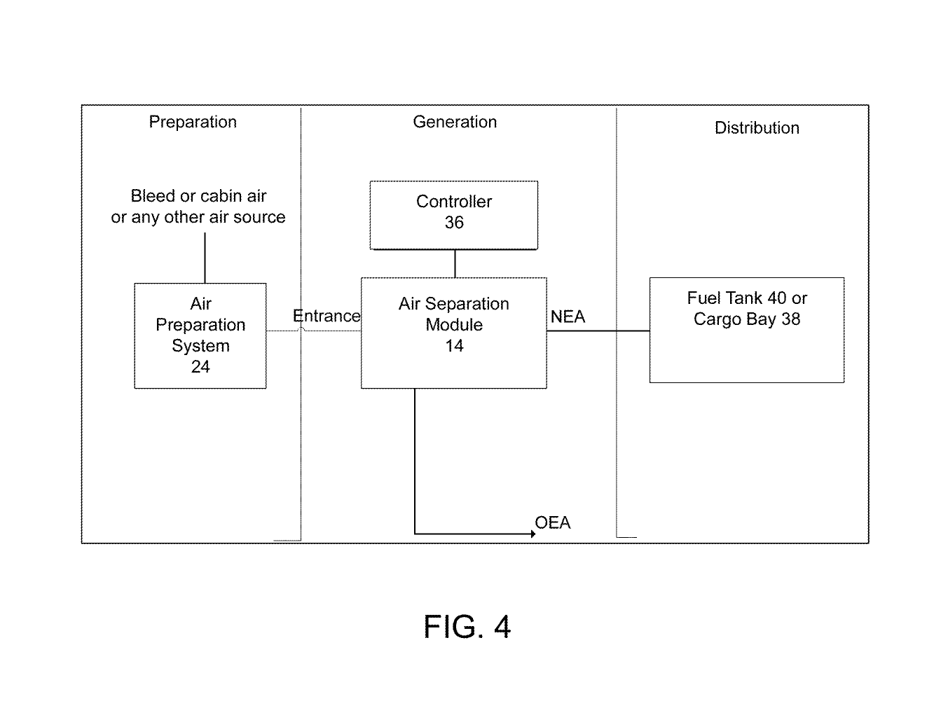

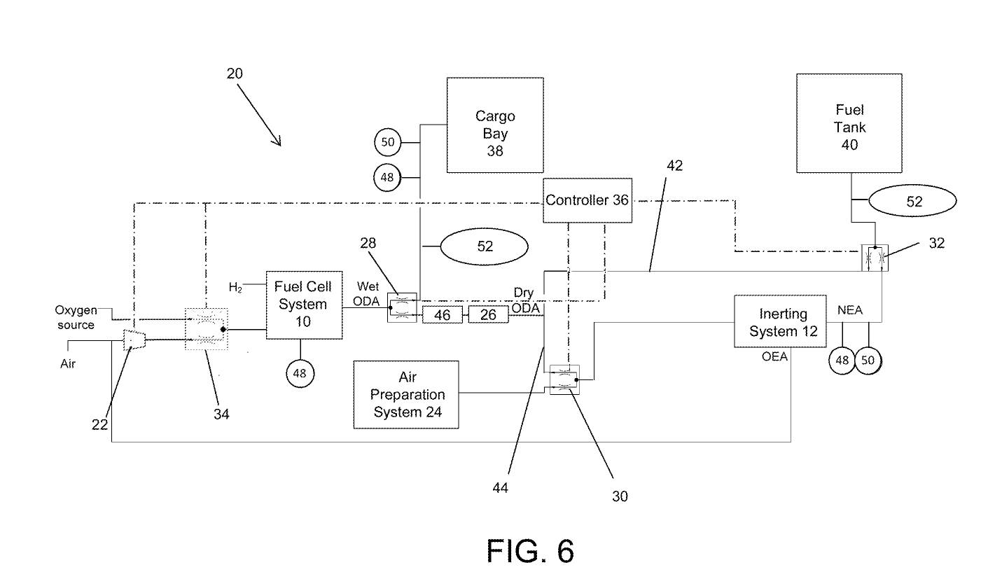

Generally, as illustrated in FIG. 4, the inerting system 12 comprises at least one air preparation system 24, at least one air separation module (“ASM”) 14, and a controller 36. In certain embodiments, as illustrated in FIG. 6, an oxygen analyzer 52 is also included to monitor the oxygen content of the inert gas leaving the ASM 14.

In certain embodiments, the air preparation system 24 is included to condition hot pressurized air output from engine combustion chambers (bleed air) to a suitable temperature and pressure. For example, bleed air entering the air preparation system 24 may be up to 450° F. A heat exchanger within the air preparation system 24 cools the bleed air to an acceptable range for introduction into the inerting system 12. For example, suitable temperatures may range from 160° F.-190° F.; however, one of ordinary skill in the relevant art will understand that any suitable temperature may be used that is compatible with the inerting system 12.

The ASM 14 separates an inlet gas stream (i.e., air) into a nitrogen enriched air (“NEA”) stream and an oxygen enriched air (“OEA”) stream. In certain embodiments, the ASM 14 is a semi-permeable hollow fiber membrane bundle contained in a pressure containment canister with three ports—a gas inlet port, an NEA outlet port, and an OEA outlet port.

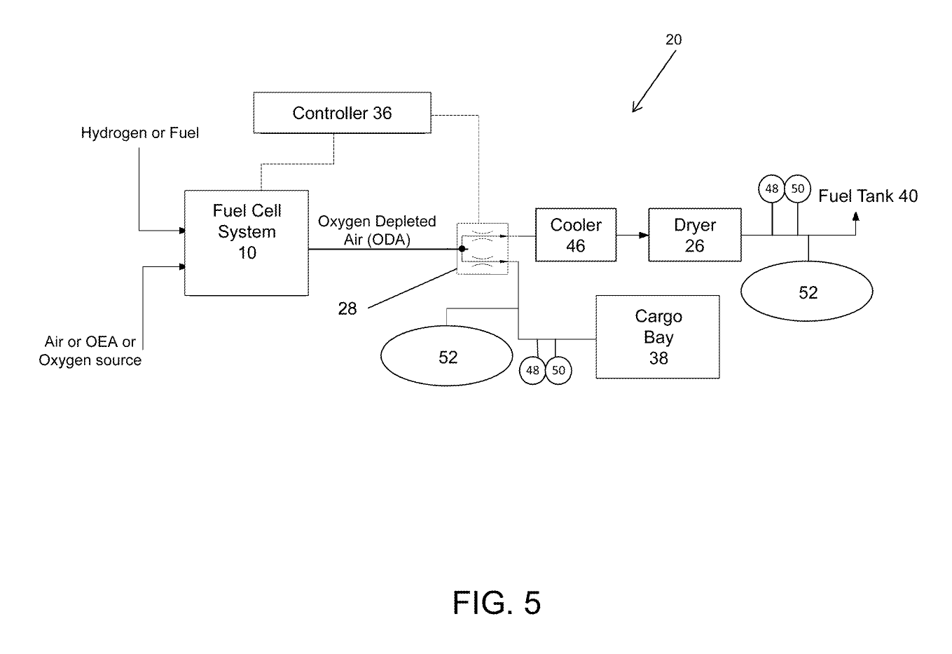

In certain embodiments, as shown in FIGS. 5-6, a fuel cell/inerting system 20 may be included to manage the operation of the fuel cell system 10 with the inerting system 12. The fuel cell/inerting system 20 may comprise at least one fuel cell system 10, at least one inerting system 12, at least one compressor 22, at least one air preparation system 24, at least one dryer 26, at least four flow selector valves 28, 30, 32, 34, and a controller 36.

As described above, hydrogen and oxygen enter the fuel cell system 10 via inlet ports, and ODA exits the fuel cell system 10 via an ODA outlet port. In these embodiments, the ODA produced by the fuel cell system 10 has a sufficiently low oxygen content to be used as an inert gas, but also contains moisture and water vapor. Because injecting the wet ODA directly into a fuel tank 40 could lead to catastrophic events, the dryer 26 or another piece of equipment, such as a filter, condenser, heat exchanger, etc., may be used alone or in combination to dry the ODA prior to direct introduction into the fuel tank 40 and/or introduction into the inerting system 12. In some embodiments, the existing inerting system 12 pipe network may be retrofitted to transport the ODA from the fuel cell system 10 to the fuel tank 40 and/or the inerting system 12. In other embodiments, a new pipe network may be constructed to transport the ODA from the fuel cell system 10 to the fuel tank 40 and/or the inerting system 12.

In contrast to the fuel tank 40, because the moisture in the wet ODA is a benefit for a cargo bay 38 fire and/or explosion, there is no need for the ODA to pass through a dryer 26 or other device to remove the moisture and/or water vapor prior to introducing the ODA into the cargo bay 38. Because cargo bays 38 have traditionally been protected with Halon, an existing pipe network may not exist to transport the ODA from the fuel cell system 10 to the cargo bay 38. Thus, in certain embodiments, a new pipe network may be constructed to transport the ODA from the fuel cell system 10 and the cargo bay 38. In some embodiments, additional piping may be added to the piping network to also transport the NEA from the inerting system 12 to the cargo bay 38.

Once the ODA reaches the fuel tank 40 and/or the cargo bay 38, the inerting gas is spread into the cargo bay 38 or injected into the vapor phase or the liquid phase of the fuel within the fuel tank 40 with nozzles and/or any other suitable distribution technology.

The at least one ODA flow selector valve 28 is coupled to the ODA outlet port of the fuel cell system 10. The ODA flow selector valve 28 controls the distribution of ODA between the cargo bay 38 and the fuel tank 40/inerting system 12. A first outlet port of the ODA flow selector valve 28 is coupled the cargo bay 38, and a second outlet port of the ODA flow selector valve 28 is coupled to a fuel tank feed line 42 and/or an inerting system feed line 44. The ODA flow selector valve 28 may be configured to (1) open both outlet ports, allowing the ODA to flow to all locations, (2) close both outlet ports (or close the inlet port), allowing no ODA to pass through the ODA flow selector valve 28, or (3) selectively close one of the two outlet ports.

The dryer 26 may be coupled to the second outlet port of the ODA flow selector valve 28 to remove moisture and water vapor from the ODA upstream of the location where the fuel tank feed line 42 and/or the inerting system feed line 44 are coupled to the second outlet port of the ODA flow selector valve 28, so that the ODA that enters the fuel tank 40 from either path is sufficiently dry for introduction into the fuel tank 40. The fuel tank feed line 42 is then coupled to a first inlet port of the fuel tank flow selector valve 32.

The at least one inerting system flow selector valve 30 includes a first inlet port that is coupled to the inerting system feed line 44, and also includes a second inlet port that is coupled to a second gas supply source, such as the outlet port of the air preparation system 24. Thus, the inerting system flow selector valve 30 controls the source of gas that is introduced to the inerting system 12. The inerting system flow selector valve 30 may be configured to (1) open both inlet ports, allowing both dry ODA and conditioned air to enter the inerting system 12, (2) close both inlet ports (or close the outlet port), allowing no gas to enter the inerting system 12, or (3) selectively close either the first inlet port or the second inlet port, so that only one of the two sources of gas enters the inerting system 12.

The at least one fuel tank flow selector valve 32 also includes a second inlet port that is coupled to the outlet port of the inerting system 12. Thus, the fuel tank flow selector valve 32 controls the source of gas that is introduced to the fuel tank 40. The fuel tank flow selector valve 32 may be configured to (1) open both inlet ports, allowing both dry ODA and NEA to enter the fuel tank 40, (2) close both inlet ports (or close the outlet port), allowing no gas to enter the fuel tank 40, or (3) selectively close either the first inlet port or the second inlet port, so that only one of the two sources of gas enters the fuel tank 40.

As described above, in some embodiments, the OEA leaving the inerting system 12 as a by-product is exhausted from the aircraft. However, in certain embodiments, the OEA may be recycled as an oxygen input to the fuel cell system 10.

For example, as described above, hydrogen and oxygen flow through inlet ports to the fuel cell system 10. In some embodiments, at least one oxygen source flow selector valve 34 is located upstream of the oxygen inlet port to the fuel cell system 10.

Cabin air, bleed air, and/or other air supply sources (pressurized and/or unpressurized) are introduced through a first inlet port of the oxygen source flow selector valve 34. The compressor 22 may be located upstream of the first inlet port to condition the pressure of the oxygen input to the fuel cell system 10 as needed to optimize the performance of the fuel cell system 10.

The OEA outlet port from the inerting system 12 may be coupled to the air line that feeds into the compressor 22 so as to provide additional source of air into the fuel cell system 10. By utilizing OEA (which has an oxygen content of greater than 21% O₂) to feed the fuel cell system 10, the higher oxygen content may be used to enhance fuel cell efficiency. For example, the controller 36 may analyze the information provided by at least one temperature sensor 48, at least one pressure sensor 50, and/or at least one oxygen analyzer 52 to optimize the operating setpoints of the fuel cell system 10, wherein such sensors 48, 50, and/or 52 may be located proximate the inlet to the cargo bay 38 and/or the fuel tank 40.

In certain embodiments, as shown in FIG. 6, one oxygen analyzer 52 may be located on the line leaving the first outlet port of the ODA flow selector valve 28, and a second oxygen analyzer 52 may be located on the line leaving the outlet port of the fuel tank flow selector valve 32. With this arrangement, the oxygen analyzers 52 are configured to measure the oxygen content of the inert gases (NEA and/or ODA) entering each of these locations.

In other embodiments, a first oxygen analyzer 52 may have an input coupled to the line leaving the first outlet port of the ODA flow selector valve 28, a second oxygen analyzer 52 may have an input coupled to the line feeding the first inlet port of the fuel tank flow selector valve 32 (fuel tank feed line 42), and a third oxygen analyzer 52 may have an input coupled to the line feeding the second inlet port of the fuel tank flow selector valve 32. Alternatively, a first oxygen analyzer 52 may have an input coupled to the line leaving the first outlet port of the ODA flow selector valve 28, and a second oxygen analyzer 52 may have at least two inputs coupled to the lines feeding the two inlet ports to the fuel tank flow selector valve 32. In yet other embodiments, a first oxygen analyzer 52 may have a first input coupled to the line leaving the first outlet port of the ODA flow selector valve 28 and a second input coupled to the line feeding the first inlet port of the fuel tank flow selector valve 32 (fuel tank feed line 42), and a second oxygen analyzer 52 may have an input coupled to the line feeding the second inlet port of the fuel tank flow selector valve 32. In still other embodiments, one oxygen analyzer 52 may have an input coupled to the line feeding the inlet port of the flow selector valve 28, and a second oxygen analyzer 52 may have an input coupled to the line feeding the second inlet port of the fuel tank flow selector valve 32. With these arrangements, the oxygen analyzers 52 are configured to separately measure the respective oxygen content of the inert gas sources.

One of ordinary skill in the relevant art will understand that the oxygen analyzers 52, as well as the temperature sensors 48 and the pressure sensors 50, may be coupled to the fuel cell/inerting system 20 in any suitable location, arrangement, or combination thereof that provides suitable feedback for the controller 36 to optimize the efficiency and throughput of the fuel cell/inerting system 20.

The OEA may be provided directly to the fuel cell system 10 from the inerting system 12, as described above, and/or may be delivered into the air stream entering the fuel cell system 10 via oxygen storage.

The oxygen source flow selector valve 34 also includes a second inlet port that is coupled to a supplemental oxygen supply source. Thus, the oxygen source flow selector valve 34 controls the source and/or may adjust oxygen content of the gas that is introduced to the fuel cell system 10. The oxygen source flow selector valve 34 may be configured to (1) open both inlet ports, allowing both the air stream (containing the OEA) and the supplemental oxygen source to enter the inerting system 12, (2) close both inlet ports (or close the outlet port), allowing no gas to enter the fuel cell system 10, or (3) selectively close either the first inlet port coupled to the air stream (containing the OEA) or the second inlet port coupled to the supplemental oxygen source, so that only one of the two sources of gas enters the fuel cell system 10.

In certain embodiments, the controller 36 may be connected to at least the flow selector valves 28, 30, 32, 34, and the compressor 22. The sensors 48, 50, and/or 52 may be included to measure at least one of temperature, pressure, and oxygen content of the NEA output from the inerting system 12, and/or the ODA output of the fuel cell system 10, wherein such sensors 48, 50, and/or 52 may be located proximate the inlet to the cargo bay 38 and/or the fuel tank 40. The outputs from these sensors 48, 50, and/or 52 may be connected to the controller 36 to optimize the operation of the fuel cell system 10 and/or the inerting system 12, as described above.

The fuel cell system 10 may be located in any suitable location on the aircraft and may be used to power other aspects of an aircraft along with the fuel cell/inerting system 20, or a separate fuel cell system 10 may be used to power the fuel cell/inerting system 20. For example, electrical power output from the fuel cell system 10 may be connected to provide power to at least the compressor 22. In other embodiments, the fuel cell system 10 may also provide power to the flow selector valves 28, 30, 32, 34, the dryer 26, the air preparation system 24, the controller 36, and/or the various measurement sensors 48, 50, and/or 52. Power needed by the fuel cell/inerting system 20 may be supplied directly by one or more fuel cell systems 10 or may be supplied or supplemented by any suitable electrical energy storage (such as battery packs, ultra capacitor banks, super capacitor banks, energy storage source, etc.) charged by power generated from a fuel cell system 10 or otherwise. Supplemental power may also be supplied by a typical power source in an aircraft, such as the ground power unit or the aircraft power unit.

If the fuel cell system 10 is positioned within or near the inerting system 12, the power is generated near the point of use and does not need to travel a long distance and therefore power dissipation is minimized. Moreover, if the fuel cell system 10 is positioned within or near the inerting system 12, the fuel cell system 10 may also be used to power other aircraft systems such as, but not limited to, passenger seats, passenger entertainment systems, emergency lighting, reading lights, lavatory units, etc., whether or not these systems are in the vicinity of the inerting system 12, so that the required energy/power output is more stable and there is less energy waste.

More than one fuel cell system 10 may be used if needed, and the size of the one or more fuel cell systems 10 may be based on the energy/power requirements of the inerting system 12 and/or other systems.

In certain embodiments, at least one battery pack or other energy source may also be connected to the fuel cell/inerting system 20 for charging during low periods and to provide additional power during high (peak) load periods, such as meal preparation/service times. In some embodiments, at least one ultra capacitor bank, a super capacitor bank, and/or an energy storage source may be used in place of or in conjunction with the battery pack or other energy source. The battery pack or other energy source may be part of the fuel cell system 10 or may be located in a separate location.

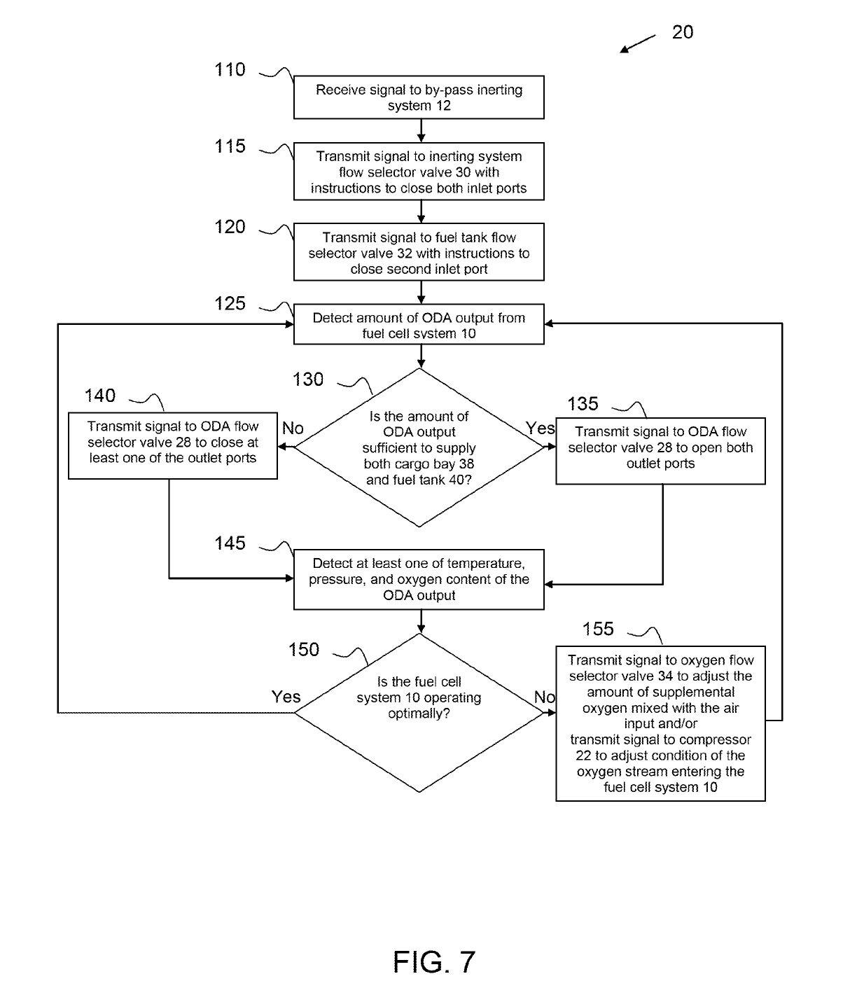

According to these embodiments, various modes of operation of the fuel cell/inerting system 20 are illustrated in simplified flow diagrams shown in FIGS. 7-9.

The fuel cell/inerting system 20 may include processing logic that may comprise hardware (circuitry, dedicated logic, etc.), software (such as is run on a general purpose computing system or a dedicated machine), firmware (embedded software), or any combination thereof.

A. Stand-Alone Inerting System

According to certain embodiments, as best illustrated in FIG. 7, the fuel cell/inerting system 20 may operate as a stand-alone inerting system. Thus, the air preparation system 24 and the inerting system 12 are not activated in these embodiments.

At step 110, the controller 36 receives a signal instructing the controller 36 to bypass the inerting system 12. The signal may be generated via a selection switch initiated by a crew member or pilot or a via a sensor that is triggered when the air preparation system 24 and/or the inerting system 12 are not functioning properly.

At step 115, the controller 36 instructs the inerting system flow selector valve 30 to close both inlet ports (or close the outlet port) so that no gas enters the inerting system 12. At step 120, the controller 36 instructs the fuel tank flow selector valve 32 to close the second inlet port supplying the NEA so that only the dry ODA flows through the fuel tank flow selector valve 32.

At step 125, the controller 36 detects the amount of ODA output from the fuel cell system 10. If, at step 130, the controller 36 determines that the amount is sufficient to supply both the cargo bay 38 and the fuel tank 40, then at step 135, the controller 36 instructs the ODA flow selector valve 28 to open both outlet ports so that the ODA is supplied to both locations. If, at step 130, the controller 36 determines that the amount of ODA output is insufficient to supply both the cargo bay 38 and the fuel tank 40, then at step 140, the controller 36 instructs the ODA flow selector valve 28 to close at least one of the outlet ports so that ODA is supplied to only one of the cargo bay 38 and the fuel tank 40. One of ordinary skill in the relevant art will understand that the particular response by the controller 36 will be dependent upon the logic programmed into the controller 36 regarding prioritizing inerting flow and efficiency.

At step 145, the controller 36 detects at least one of temperature, pressure, and oxygen content of the ODA output from the fuel cell system 10 via sensors 48, 50, and/or 52 located proximate the inlet to the cargo bay 38 and/or the fuel tank 40. If, at step 150, the controller 36 determines that the fuel cell system 10 is not operating optimally, then at step 155, the controller 36 may instruct the oxygen source flow selector valve 34 to adjust the amount of supplemental oxygen that is mixing with the air input and/or may instruct the compressor 22 to adjust the condition of the oxygen stream entering the fuel cell system 10.

The controller 36 repeats steps 125-155 as frequently as needed to maximize the efficient use of the ODA output from the fuel cell system 10.

According to certain embodiments, as illustrated in FIG. 5, the fuel cell system 10 may be used directly to supply inert gas to the fuel tank 40 and/or the cargo bay 38 without the need for the inerting system 12, the air preparation system 24, or the flow selector valves 30 or 32. Thus, in these embodiments, steps 110-120 are eliminated because there is no need to bypass the inerting system 12.

Furthermore, in certain embodiments, at least one cooler 46 may be located upstream of the dryer 26, as illustrated in FIGS. 5 and 6.

B. Source of ODA for Inerting System

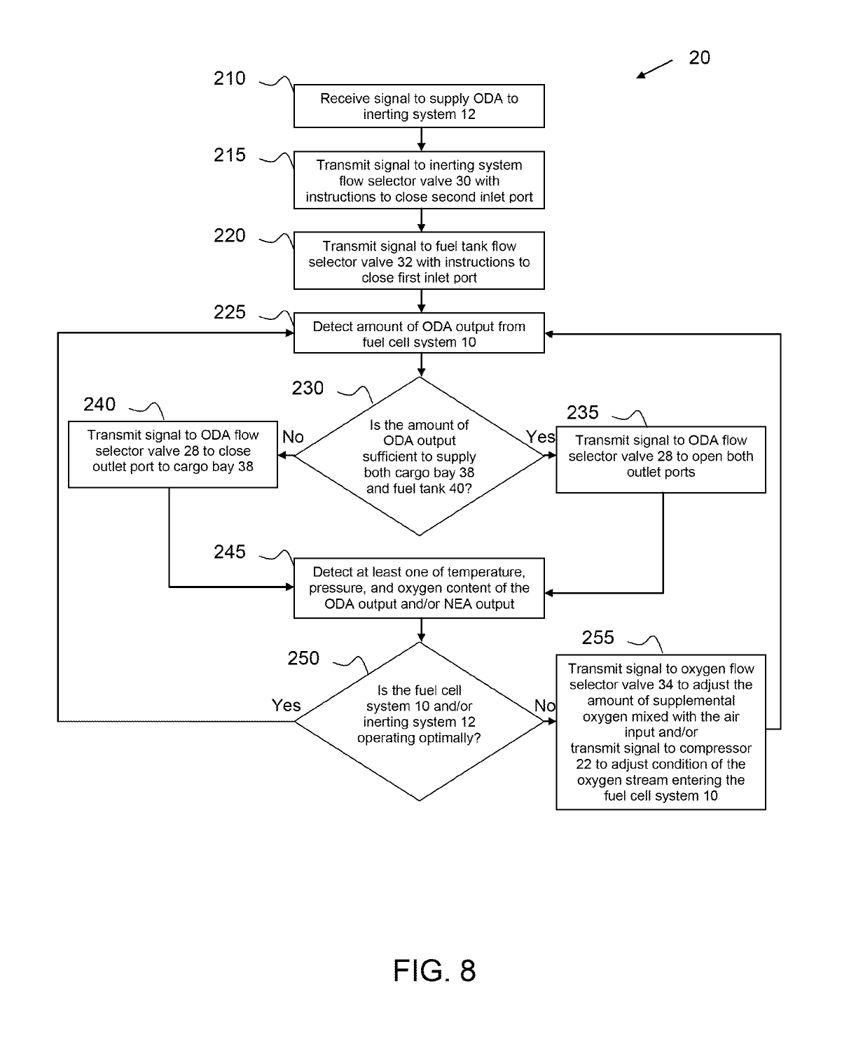

According to certain embodiments, as best illustrated in FIG. 8, the fuel cell/inerting system 20 may operate so that the ODA leaving the fuel cell system 10 provides a source of ODA to the inerting system 12. Thus, the air preparation system 24 and the flow of dry ODA directly to the fuel tank 40 are not activated in these embodiments.

At step 210, the controller 36 receives a signal instructing the controller 36 to supply ODA to the inerting system 12. The signal may be generated via a selection switch initiated by a crew member or pilot or a via a sensor that is triggered when the air preparation system 24 is not functioning properly.

At step 215, the controller 36 instructs the inerting system flow selector valve 30 to close the second input supplying the conditioned air from the air preparation system 24 so that only the dry ODA enters the inerting system 12. At step 220, the controller 36 instructs the fuel tank flow selector valve 32 to close the first inlet port supplying the dry ODA so that only the NEA flows through the fuel tank flow selector valve 32.

At step 225, the controller 36 detects the amount of ODA output from by the fuel cell system 10. If, at step 230, the controller 36 determines that the amount is sufficient to supply both the cargo bay 38 and the fuel tank 40, then at step 235, the controller 36 instructs the ODA flow selector valve 28 to open both outlet ports so that the ODA is supplied to both locations. If, at step 230, the controller 36 determines that the amount of ODA output is insufficient to supply both the cargo bay 38 and the fuel tank 40, then at step 240, the controller 36 instructs the ODA flow selector valve 28 to close the outlet port to the cargo bay 38, so that only the outlet port to the dryer 26 is open. One of ordinary skill in the relevant art will understand that the particular response by the controller 36 will be dependent upon the logic programmed into the controller 36 regarding prioritizing inerting flow and efficiency.

At step 245, the controller 36 detects at least one of temperature, pressure, and oxygen content of the ODA output from the fuel cell system 10 and/or the NEA output from the inerting system 12 via sensors 48, 50, and/or 52 located proximate the inlet to the cargo bay 38 and/or the fuel tank 40. If, at step 250, the controller 36 determines that the fuel cell system 10 and/or the inerting system 12 is not operating optimally, then at step 255, the controller 36 may instruct the oxygen source flow selector valve 34 to adjust the amount of supplemental oxygen that is mixing with the air input and/or may instruct the compressor 22 to adjust the condition of the oxygen stream entering the fuel cell system 10.

By supplying the inerting system 12 with ODA (instead of air with the standard oxygen content), the inerting system 12 efficiency is increased because the oxygen content in the ODA supplied to the inerting system 12 is lower than standard air, so that the resulting NEA also contains less oxygen.

Furthermore, the fuel cell system 10 efficiency is also increased due to the higher oxygen content in the air at the compressor input. In other words, a lower total air flowrate is needed to achieve the same oxygen flowrate.

The controller 36 repeats steps 225-255 as frequently as needed to maximize the efficient use of the ODA output from the fuel cell system 10.

Furthermore, in certain embodiments, at least one cooler 46 may be located upstream of the dryer 26, as illustrated in FIG. 6.

C. Mass Flow Booster

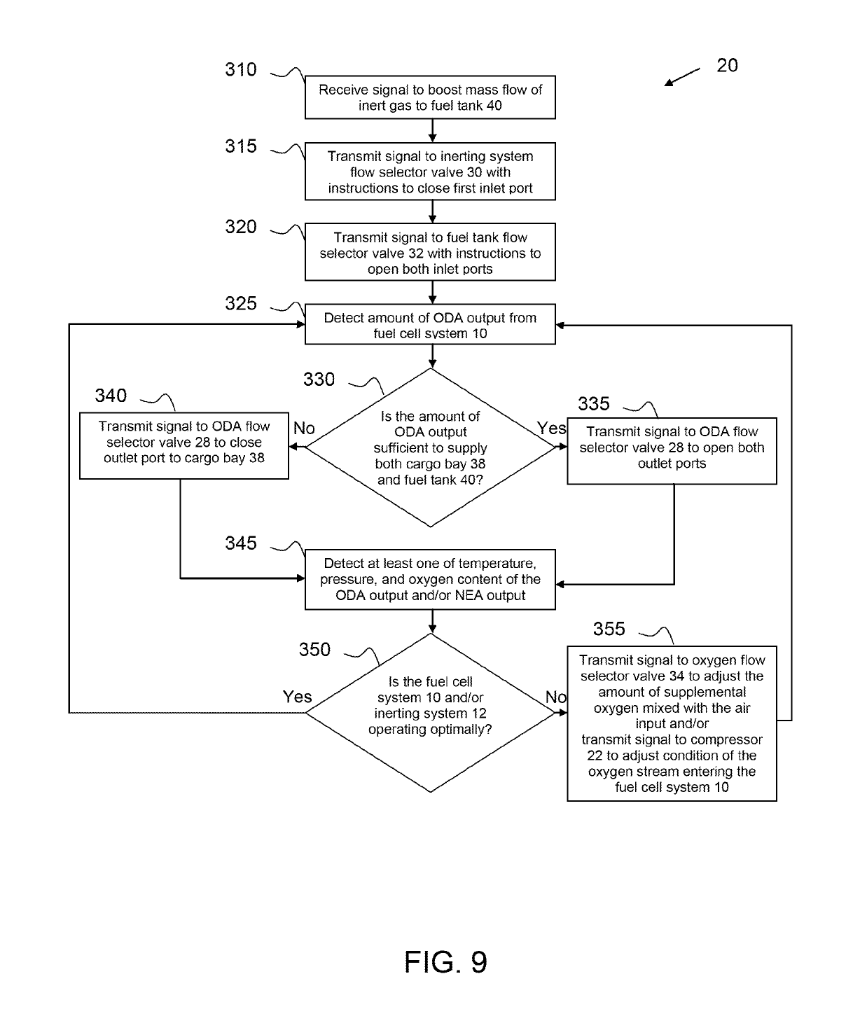

According to certain embodiments, as best illustrated in FIG. 9, the fuel cell/inerting system 20 may operate so that the ODA leaving the fuel cell system 10 provides a mass flow booster to the overall fuel cell/inerting system 20.

At step 310, the controller 36 receives a signal instructing the controller 36 to boost a mass flow of inert gas to the fuel tank 40. The signal may be generated via a selection switch initiated by a crew member or pilot or a via a sensor that is triggered when additional throughput of inerting gas to the fuel tank 40 is needed.

At step 315, the controller 36 instructs the inerting system flow selector valve 30 to close the first inlet port supplying dry ODA so that only the conditioned air from the air preparation system 24 enters the inerting system 12. At step 320, the controller 36 instructs the fuel tank flow selector valve 32 to open both inlet ports so that the dry ODA and the NEA flow through both inlet ports of the fuel tank flow selector valve 32.

At step 325, the controller 36 detects the amount of ODA output from by the fuel cell system 10. If, at step 330, the controller 36 determines that the amount is sufficient to supply both the cargo bay 38 and the fuel tank 40, then at step 335, the controller 36 instructs the ODA flow selector valve 28 to open both outlet ports so that the ODA is supplied to both locations. If, at step 330, the controller 36 determines that the amount of ODA output is insufficient to supply both the cargo bay 38 and the fuel tank 40, then at step 340, the controller 36 instructs the ODA flow selector valve 28 to close the outlet port to the cargo bay 38, so that only the outlet port to the dryer 26 is open. One of ordinary skill in the relevant art will understand that the particular response by the controller 36 will be dependent upon the logic programmed into the controller 36 regarding prioritizing inerting flow and efficiency.

At step 345, the controller 36 detects at least one of temperature, pressure, and oxygen content of the ODA output from the fuel cell system 10 and/or the NEA output from the inerting system 12 via sensors 48, 50, and/or 52 located proximate the inlet to the cargo bay 38 and/or the fuel tank 40. If, at step 350, the controller 36 determines that the fuel cell system 10 and/or the inerting system 12 is not operating optimally, then at step 355, the controller 36 may instruct the oxygen source flow selector valve 34 to adjust the amount of supplemental oxygen that is mixing with the air input and/or may instruct the compressor 22 to adjust the condition of the oxygen stream entering the fuel cell system 10.

By not passing the ODA through the inerting system 12, the whole inerting capabilities of the fuel cell/inerting system 20 are increased through the increased available mass flow quantity (ODA from the fuel cell system 10 and the NEA from the inerting system 12), as compared to other configurations.

The controller 36 repeats steps 325-355 as frequently as needed to maximize the efficient use of the ODA output from the fuel cell system 10.

Furthermore, in certain embodiments, at least one cooler 46 may be located upstream of the dryer 26, as illustrated in FIG. 6.

D. Fuel Scrubber

According to certain embodiments, as best illustrated in FIG. 7, the fuel cell/inerting system 20 may operate so that the ODA leaving the fuel cell system 10 provides a fuel scrubber to the overall fuel cell/inerting system 20. Thus, the air preparation system 24 and the inerting system 12 are not activated in these embodiments.

In these embodiments, the fuel cell/inerting system 20 follows steps 110-155, as described above with respect to embodiments where the fuel cell/inerting system 20 is configured to operate as a stand-alone inerting system. However, instead of introducing the dry ODA into the vapor phase of the fuel tank 40 as described with respect to the stand-alone inerting system embodiments, the dry ODA is injected into the liquid phase of the fuel within the fuel tank 40. By introducing the ODA into the liquid phase of the fuel, the nitrogen is dissolved in the fuel (due to the ODA bubbling in the fuel) according to its solubility. As the atmospheric pressure decreases within the fuel tank 40, the nitrogen escapes from the fuel and enriches the vapor phase of the tank.

According to certain embodiments, as illustrated in FIG. 5, the fuel cell system 10 may be used directly to supply inert gas to the fuel tank 40 and/or the cargo bay 38 without the need for the inerting system 12, the air preparation system 24, or the flow selector valves 30 or 32. Thus, in these embodiments, steps 110-120 are eliminated because there is no need to bypass the inerting system 12.

Furthermore, in certain embodiments, at least one cooler 46 may be located upstream of the dryer 26, as illustrated in FIGS. 5 and 6.

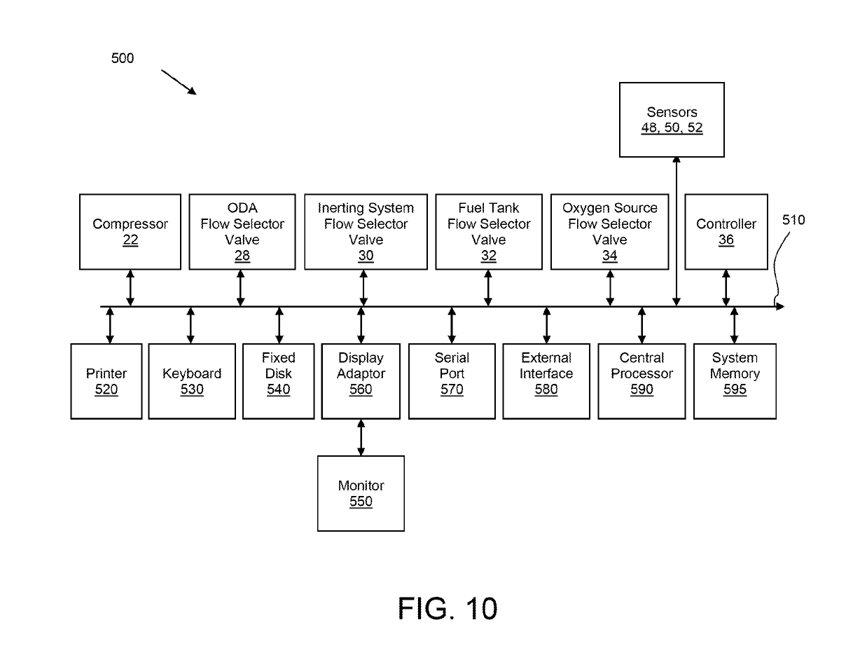

FIG. 10 is a diagram of a computer apparatus 500, according to certain exemplary embodiments. The various participants and elements in the previously described system diagrams (e.g., the fuel cell/inerting system 20 in FIGS. 5-6) may use any suitable number of subsystems in the computer apparatus 500 to facilitate the functions described herein. Examples of such subsystems or components are shown in FIGS. 5-6. The subsystems or components shown in FIG. 5-6 may be interconnected via a system bus 510 or other suitable connection. In addition to the subsystems described above, additional subsystems such as a printer 520, keyboard 530, fixed disk 540 (or other memory comprising computer-readable media), monitor 550, which is coupled to a display adaptor 560, and others are shown. Peripherals and input/output (I/O) devices (not shown), which couple to the controller 36 can be connected to the system 500 by any number of means known in the art, such as a serial port 570. For example, the serial port 570 or an external interface 580 may be used to connect the control system 500 to a wide area network such as the Internet, a mouse input device, or a scanner. The interconnection via the system bus 510 allows a central processor 590 to communicate with each subsystem and to control the execution of instructions from a system memory 595 or the fixed disk 540, as well as the exchange of information between subsystems. The system memory 595 and/or the fixed disk 540 may embody a computer-readable medium.

The software components or functions described in this application may be implemented via programming logic controllers (“PLCs”), which may use any suitable PLC programming language. In other embodiments, the software components or functions described in this application may be implemented as software code to be executed by one or more processors using any suitable computer language such as, for example, Java, C++ or Perl using, for example, conventional or object-oriented techniques. The software code may be stored as a series of instructions or commands on a computer-readable medium, such as a random access memory (“RAM”), a read-only memory (“ROM”), a magnetic medium such as a hard-drive or a floppy disk, an optical medium such as a CD-ROM, or a DNA medium. Any such computer-readable medium may also reside on or within a single computational apparatus, and may be present on or within different computational apparatuses within a system or network.

The invention can be implemented in the form of control logic in software or hardware or a combination of both. The control logic may be stored in an information storage medium as a plurality of instructions adapted to direct an information processing device to perform a set of steps disclosed in embodiments of the invention. Based on the disclosure and teachings provided herein, a person of ordinary skill in the art will appreciate other ways and/or methods to implement the invention.

In embodiments, any of the entities described herein may be embodied by a computer that performs any or all of the functions and steps disclosed.

The foregoing is provided for purposes of illustrating, explaining, and describing embodiments of the invention. Further modifications and adaptations to these embodiments will be apparent to those skilled in the art and may be made without departing from the scope or spirit of the invention. As one example, instead of a fuel cell system, another suitable power source that is independent from the aircraft's main power system may be used.

That which is claimed is:

1. A fuel cell/inerting system comprising:
(a) at least one fuel cell system comprising a fuel tank feed line and an inerting system feed line;
(b) at least one inerting system comprising a gas inlet port and an NEA outlet port;
(c) at least one inerting system flow selector valve comprising a first inlet port coupled to the inerting system feed line of the at least one fuel cell system, a second inlet port coupled to a second gas supply source, and an outlet port coupled to the gas inlet port of the at least one inerting system;
(d) at least one fuel tank flow selector valve comprising a first inlet port coupled to the fuel tank feed line of the at least one fuel cell system, a second inlet port coupled to the NEA outlet port of the at least one inerting system, and an outlet port coupled to a fuel tank;
(e) a controller;
(f) one or more processors in communication with the controller, the at least one inerting system flow selector valve, and the at least one fuel tank flow selector valve; and
(g) memory including instructions that, when executed by the one or more processors, cause the one or more processors to:
receive a signal instructing the controller to bypass the at least one inerting system, to supply ODA to the at least one inerting system, or to boost a mass flow to the fuel tank;
transmit a signal to the at least one inerting system flow selector valve instructing the at least one inerting system flow selector valve to perform at least one of (i) closing both inlet ports when the controller is instructed to bypass the at least one inerting system, (ii) closing the second inlet port coupled to the second gas supply source when the controller is instructed to supply ODA to the at least one inerting system, or (iii) closing the first inlet port coupled to the inerting system feed line of the at least one fuel cell system when the controller is instructed to boost the mass flow to the fuel tank; and
transmit a signal to the at least one fuel tank flow selector valve instructing the at least one fuel tank flow selector valve to perform at least one of (i) closing the second inlet port coupled to the NEA outlet port of the at least one inerting system when the controller is instructed to bypass the at least one inerting system, (ii) closing the first inlet port coupled to the fuel tank feed line of the at least one fuel cell system when the controller is instructed to supply ODA to the at least one inerting system, or (iii) opening both inlet ports when the controller is instructed to boost the mass flow to the fuel tank.

2. The fuel cell/inerting system of claim 1, wherein the second gas supply source comprises at least one air preparation system.

3. The fuel cell/inerting system of claim 1, further comprising at least one ODA flow selector valve comprising an inlet port coupled to an ODA outlet port of the at least one fuel cell system, a first outlet port coupled to a cargo bay, and a second outlet port coupled to the inerting system feed line and the fuel tank feed line.

4. The fuel cell/inerting system of claim 3, further comprising at least one dryer coupled to the second outlet port of the at least one ODA flow selector valve.

5. The fuel cell/inerting system of claim 3, wherein the instructions, when executed by the one or more processors, cause the one or more processors to:
detect an amount of ODA output from the at least one fuel cell system; and
transmit a signal to the at least one ODA flow selector valve instructing the at least one ODA flow selector valve to open both outlet ports when the controller determines that the amount of ODA output is sufficient to supply the cargo bay and the fuel tank or close one of the two outlet ports when the controller determines that the amount of ODA output is insufficient to supply the cargo bay and the fuel tank.

6. The fuel cell/inerting system of claim 1, further comprising at least one oxygen source flow selector valve comprising a first inlet port coupled to an air supply source and a second inlet port coupled to a supplemental oxygen source.

7. The fuel cell/inerting system of claim 6, further comprising at least one compressor coupled to the first inlet port of the at least one oxygen source flow selector valve.

8. The fuel cell/inerting system of claim 7, wherein the instructions, when executed by the one or more processors, cause the one or more processors to:
detect at least one of temperature, pressure, and oxygen content of ODA output from the at least one fuel cell system or at least one of temperature, pressure, and oxygen content of NEA output from the at least one inerting system; and
transmit a signal to the at least one compressor to adjust a condition of the air supply entering the at least one fuel cell system when the controller determines that the at least one fuel cell system and/or the at least one inerting system is not operating optimally.

9. The fuel cell/inerting system of claim 8, wherein the instructions, when executed by the one or more processors, cause the one or more processors to:
transmit a signal to the at least one oxygen source flow selector valve instructing the at least one oxygen source flow selector valve to open both inlet ports to adjust the amount of supplemental oxygen that is mixing with the air supply when the controller determines that the at least one fuel cell system and/or the at least one inerting system is not operating optimally.

10. The fuel cell/inerting system of claim 6, wherein an OEA outlet port of the at least one inerting system is coupled to the air supply source.

11. The fuel cell/inerting system of claim 7, wherein an electrical power output of the at least one fuel cell system is connected to the at least one compressor.

12. A fuel cell/inerting system comprising:
(a) at least one fuel cell system comprising an ODA outlet port;
(b) at least one dryer coupled to a fuel tank;
(c) at least one ODA flow selector valve comprising an inlet port coupled to the ODA outlet port of the at least one fuel cell system, a first outlet port coupled to a cargo bay, and a second outlet port coupled to the at least one dryer;
(d) a controller;
(e) one or more processors in communication with the controller and the at least one ODA flow selector valve; and
(f) memory including instructions that, when executed by the one or more processors, cause the one or more processors to:
detect an amount of ODA output from the at least one fuel cell system; and
transmit a signal to the at least one ODA flow selector valve instructing the at least one ODA flow selector valve to open both outlet ports when the controller determines that the amount of ODA output is sufficient to supply the cargo bay and a fuel tank or close one of the two outlet ports when the controller determines that the amount of ODA output is insufficient to supply the cargo bay and the fuel tank.

13. The fuel cell/inerting system of claim 12, further comprising at least one oxygen source flow selector valve comprising a first inlet port coupled to an air supply source and a second inlet port coupled to a supplemental oxygen source.

14. The fuel cell/inerting system of claim 13, further comprising at least one compressor coupled to the first inlet port of the at least one oxygen source flow selector valve.

15. The fuel cell/inerting system of claim 14, wherein the instructions, when executed by the one or more processors, cause the one or more processors to:
detect at least one of temperature, pressure, and oxygen content of ODA output from the at least one fuel cell system; and
transmit a signal to the at least one compressor to adjust a condition of the air supply entering the at least one fuel cell system when the controller determines that the at least one fuel cell system is not operating optimally.

16. The fuel cell/inerting system of claim 15, wherein the instructions, when executed by the one or more processors, cause the one or more processors to:
transmit a signal to the at least one oxygen source flow selector valve instructing the at least one oxygen source flow selector valve to open both inlet ports to adjust the amount of supplemental oxygen that is mixing with the air supply when the controller determines that the at least one fuel cell system is not operating optimally.

17. The fuel cell/inerting system of claim 14, wherein an electrical power output of the at least one fuel cell system is connected to the at least one compressor.

18. The fuel cell/inerting system of claim 12, further comprising at least one cooler located upstream of the at least one dryer and coupled to the second outlet port of the at least one ODA flow selector valve.

19. A method of operating a fuel cell/inerting system, the fuel cell/inerting system comprising at least one fuel cell system, at least one dryer, at least one compressor, and a controller, the method comprising:
detecting at least one of temperature, pressure, and oxygen content of ODA output from the at least one fuel cell system; and
transmitting a signal to the at least one compressor to adjust a condition of the air supply entering the at least one fuel cell system when the controller determines that the at least one fuel cell system is not operating optimally.

20. The method of claim 19, further comprising at least one oxygen source flow selector valve comprising a first inlet port coupled to an air supply source and a second inlet port coupled to a supplemental oxygen supply source, wherein the method further comprises:
transmitting a signal to the at least one oxygen source flow selector valve instructing the at least one oxygen source flow selector valve to open both inlet ports to adjust the amount of supplemental oxygen that is mixing with the air supply when the controller determines that the at least one fuel cell system is not operating optimally.
